(19) United States
(12) Patent Application Publication
(10) Pub. No.: US 2014/0144350 A1
(43) Pub. Date: May 29, 2014

(54) HYDRAULIC BINDER

(71) Applicant: HOLCIM TECHNOLOGY LTD., Rapperswil-Jona (CH)

(72) Inventors: Winnie Matthes, Aarau (CH); Zarina Castelltort, Rolle (CH); Thomas Matschei, Lenzburg (CH); Moussa Baalbaki, Moriken (CH)

(73) Assignee: HOLCIM TECHNOLOGY LTD., Rapperswil-Jona (CH)

(21) Appl. No.: 14/131,503

(22) PCT Filed: Jul. 9, 2012
(86) PCT No.: PCT/IB2012/001357

§ 371 Date: Feb. 3, 2014

(30) Foreign Application Priority Data
Jul. 8, 2011 (AT) A 1005/2011

(51) Int. Cl. C04B 22/14; C04B 24/04; C04B 22/08; C04B 24/06

(52) U.S. Cl. CPC C04B 22/147; C04B 24/06; C04B 24/04; C04B 22/085
USPC 106/708; 106/778; 106/781; 106/774; 106/810; 106/806

(57) ABSTRACT

A hydraulic binder containing 25 to 85 wt % of cement clinker, 0 to 7 wt % of CaSO₄, a mineral additive(s), and 1 to 10 wt % of a dual setting control system that includes an activator and a retarder, in a weight ratio of activator to retarder, based on the dry substance selected to be greater than 85:15, in particular greater than 90:10, more particularly greater than 95:5, and, in particular, greater than 98:2.

The invention relates to a hydraulic binder containing 25 to 85 wt % of cement clinker, 0 to 7 wt % of CaSO₄, and mineral additives. The invention further relates to an activating system and the use of said hydraulic binder and activating system in a ready-mix concrete mixture.

Concrete is a very widely used construction material with high strength and good durability. In addition to aggregates and water, it also contains as a hydraulic binder Portland cement, which produces strength-forming phases by solidifying and curing in contact with water. Concrete based on Portland cement clinker is thus one of the most important binders worldwide.

Cements based on Portland cement clinker contain calcium sulfate (CaSO₄) to control setting and curing. Calcium sulfate reacts with the aluminate clinker phases to initially form ettringite. After the consumption of calcium sulfate, and in the absence of carbonate, nitrate, chloride, etc., the formed ettringite gradually transforms into hydrate phases with low sulfate portions. Calcium sulfate sources in that case include gypsum, semi-hydrate, anhydrite or mixtures of two or more of these substances.

By adding various additives such as, e.g., granulated blast-furnace slag (gbfs), fly ash, natural puzzolans, calcined clays or ground limestone to Portland cement, Portland composite cements having different properties can be produced. At the same time, the specific emission of CO₂ will be reduced in the production of cement by substituting the cited additives for Portland cement, because during the production of Portland cement clinker about 0.9 tons of CO₂ per ton of Portland cement clinker will be emitted by the calcination of the raw materials and from the oxidation of the fuels in the rotary tubular kiln. The addition of additives to Portland cement has been an established practice for more than 100 years and is regulated in numerous cement and concrete standards. The substitution of additives for Portland cement clinker in cement or concrete, however, involves a reduction of the strength and, above all, of the early strength such that measures have to be taken to achieve sufficient strengths despite the desired, reduced content of Portland cement clinker.

One of these measures comprises the chemical activation, for instance by alkali compounds. Portland cements including mineral additives such as slag sand or fly ash exhibit elevated strengths upon alkali excitation or activation. However, the processability of mortar or concrete will at the same time be considerably lowered. A Portland slag or blast furnace slag cement clinker with the designation CEM III according to EN 197 (Austrian Standards), to which an alkali activator is mixed, can, for instance, be taken from WO 2007/039694 A2. Such cement, however, involves the drawbacks of a reduced final strength and a short processing time because of the early setting of the concrete. An acid/base activation at a controlled pH as described in U.S. Pat. No. 6,827,776 B1 and U.S. Pat. No. 6,740,155 B1, for instance, leads to the very rapid setting and curing of fly ash composite cements at initial setting times up to 38 minutes and final setting times up to 46 minutes.

As opposed to the activation of Portland cement with lime and alkali compounds, WO 92/06048 describes a different activation strategy for granulated blast-furnace slag composite cements containing less than 30 wt % of Portland cement, based on a combination of magnesium oxide and phosphates. The resulting concrete has been proven to be refractory. The formulations have very low early strengths unless a small amount of an alkali compound along with lime, amorphous silicon and a plasticizer is added.

U.S. Pat. No. 5,490,889 demonstrates how the processing time or processability and strength development of mixed hydraulic compositions can be controlled by the delayed addition of the activator along with a careful adjustment of the addition of 5 to 9 different cement components. The hydraulic composition contains 15 to 22 wt % of water, 50 to 83 wt % of calcareous fly ash (class C according to ASTM C618), and 5 to 23 wt % of cement materials comprising Portland cement, ground granulated blast-furnace slag, which is referred to as slag sand in the following, and optionally ground silicon, the whole being activated by a combination of citric acid and an alkali metal activator with boric acid and/or borax. According to that prior art, the processing time of between some few minutes and more than one hundred hours is substantially controllable by the delayed addition of the activator, citric acid, and the alkali metal activator. When operating at water/cement ratios of below 0.25, good strengths of the examined mortars were reported. Yet, due to the complexity of the formulation, it is doubtful whether these values would be achieved with a concrete under practical application conditions at varying temperatures, different aggregate qualities, etc.

The present invention aims to reproducibly achieve a significant improvement of the strength, in particular in early phases, while the processability or processing time relative to a non-activated, comparative cement is to be at least maintained.

To solve this object, the invention, departing from a hydraulic binder of the initially defined kind, essentially consists in that 1 to 10 wt % of a dual setting control system is contained, which comprises an activator and a setting retarder, wherein the weight ratio of activator to retarder, based on the dry substance, is selected to be greater than 85:15, in particular greater than 90:10, in particular greater than 95:5, in particular greater than 98:2. In this respect, Applicant surprisingly found that in terms of strength, in both the early and late phases of setting and curing, smaller portions of cement clinker can at least be compensated for by the use of the dual setting control system according to the invention. In doing so, the conventional advantages of the activator will be combined with those of the retarder if the claimed ratios are met. The activator, which in the examples is primarily comprised of Na₂SO₄, significantly accelerates the hydration reactions of both clinker and secondary cement materials. As a result, the early strength of the accelerated composite cements will significantly increase on setting days 1 and 2. In the prior art, this has however been accomplished at the expense of the late strength development after 28 days. According to the invention, the combined addition of an activator and a retarder prevents this frequently observed loss of late strength without influencing the effect in the early activation. In addition, the processability of the cement in mortar and concrete has been significantly improved.

Calorimetric measurements along with thermodynamic calculations have shown that the combined activation system comprising a retarder and an activator improves the degree of hydration from the first day of setting. Although the combined activation system according to the invention has a relatively low degree of hydration on setting day 1 as compared to known activated systems, the early strength development of these two systems is comparable and significantly higher than that of the non-activated system.

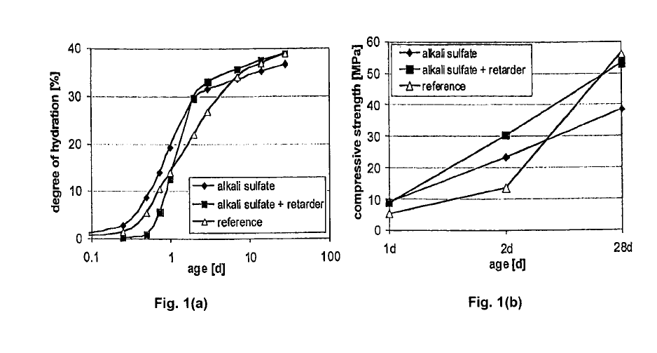

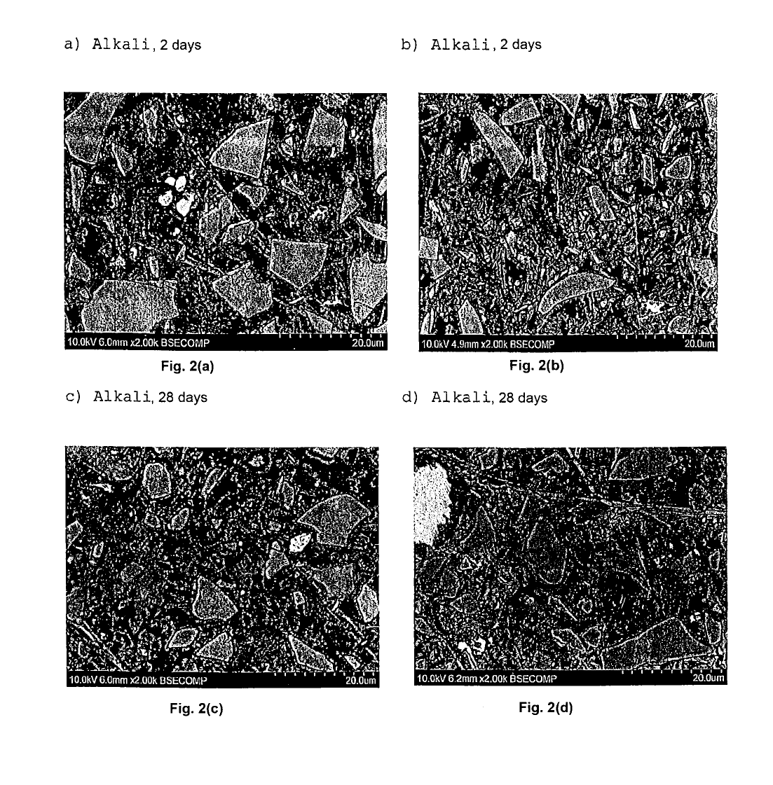

SEM (scanning electron microscopy) images (cf. FIG. 2) reveal that the joint addition of an activator (e.g. Na₂SO₄ in the present case) and a retarder (e.g. Na gluconate in the present case) results in a denser microstructure, which enhances the mechanical behavior of the combined activation system. The higher volume portions of the reaction products calcium/silicate/hydrate and ettringite in cements containing combined activation systems as calculated from one day of hydration time, based on the chemically bound water, conform to these observations.

Due to the presence of a retarder, the dual setting control system can altogether be used in higher amounts relative to the overall mixture of the cement. While the use of activators has so far been made in amounts up to about 1 wt %, based on the weight of the hydraulic binder, the combination with the retarder allows for the use of amounts up to 10 wt %, and hence the corresponding increase in strength. In a preferred manner, the dual setting control system is used in amounts of from 1 to 7 wt %, in particular 2 to 3 wt %, based on the hydraulic binder.

The activator preferably comprises one or several earth alkali or alkali compounds, in particular at least one compound selected from the group consisting of carbonates, chlorides, sulfates, nitrates, nitrites, thiocyanates, thiosulfates, and salts of organic acids such as, e.g., formiates and acetates, of alkali metals, in particular Na, K or Li. The activator, in combination with at least one of the aforementioned compounds, preferably further comprises at least one compound selected from the group consisting of polyalcohols, in particular triethanolamine or triisopropanolamine, glycerol or glycol derivatives. In a preferred manner, the activator is used in amounts of from 1 to 6 wt %, in particular 2 to 4 wt %, based on the hydraulic binder. The use of Na₂SO₄ as an activator is particularly preferred. Said activator enhances the formation of ettringite, which results in a reduced porosity due to an increased water-binding capacity.

The retarder preferably comprises at least one compound selected from the group consisting of Zn and lead salts, phosphates, phosphonates, in particular phosphonobutanetricarboxylic acid, aminomethylene phosphonate, in particular amino-tris-methylene phosphonate, borates and boric acids, silicofluorides, organic acids, in particular hydroxycarboxylic acids, in particular gluconic acid, citric acid, tartaric acid, and salts thereof, sugars and derivatives thereof, as well as compounds based on lignin or lignosulfonates. The sugars can be mono-, di- and oligosaccharides. By sugar derivatives, in particular sugar alcohols such as sorbitol are to be understood. Particularly preferred is the use of an alkali metal salt and/or earth alkali metal salt of gluconic acid, in particular Na gluconate, as a retarder. The retarder is preferably used in an amount of from 0.01-0.5 wt %, in particular 0.03-0.06 wt %, based on the hydraulic binder.

As already mentioned in the beginning, mineral additives are used in hydraulic binders that are based on cement clinker and in which the clinker factor is reduced; in order to compensate for the reduced portion of Portland cement clinker. In the context of the present invention, these preferably comprise slag sand, fly ash, natural puzzolans, burnt clays, ground limestone, or combinations thereof. Particularly preferred is the combination of slag sand and limestone. The mineral additives are preferably contained in amounts of from 15 to 75 wt %, based on the hydraulic binder. If fly ash or natural puzzolans are used as additives, reactive clays, in particular metakaolin, may be additionally contained in amounts of from 1 to 15 wt %, based on the hydraulic binder, in order to further enhance the strength development and allow for a further reduction of the clinker content.

The hydraulic binders according to the invention are cements of the groups CEM II/A,B, CEM III/A,B, CEM IV/A,B and CEM V/A,B according to EN 197-1, and compositions non included in EN 197-1 such as, for instance, a cement comprising 65 wt % of slag sand and 10 wt % of limestone, or a CEM V composition containing 10 wt % of limestone. Basically, the content of mineral additives ranges between 15 and 75 wt %. This means that the clinker content may vary from 25 to 85 wt %. The portion of mineral additives, in particular puzzolanic components such as silica-rich fly ashes, natural puzzolans or burnt clays ranges from 0 to 70 wt %, limestone as a mineral additive may be contained in amounts of from 0 to 50 wt %, and latently hydraulic materials such as slag sand or calcareous fly ashes may range from 0 to 75 wt %.

The activation system according to the invention is characterized by a dual setting control system comprising an activator and a retarder, wherein the ratio of activator to retarder is selected to be greater than 85:15, in particular greater than 90:10, in particular greater than 95:5, in particular greater than 98:2. Concerning the advantageous embodiments, it is referred to the above statements in terms of hydraulic binder. The activation system either is present as a component of the hydraulic binder or may not be added until mixing the concrete or mortar.

The hydraulic binder according to the invention, and the activation system according to the invention, can be further processed to a ready-mix concrete mixture as defined in claims 20 to 22.

The present invention will be explained in more detail by way of the following exemplary embodiments.

### EXAMPLE 1

Various composite cements were used in mortars containing 450 g cement and 1350 g EN standard sand. The water/cement ratio varied. Table 1 indicates the results for the compressive strengths of these mortars as compared to non-activated comparative cements, cements comprising an activator, cements comprising a retarder, and cements comprising the combined activation system according to the invention.

TABLE 1

| | | Activator | | Retarder | | Compressive strength, MPa | | |
|---|---|---|---|---|---|---|---|---|
| Mortar, 20° C. | Activator | wt % | Retarder | wt % | w/c | 1d | 2d | 28d |

A) 57.4 wt % of clinker, 38.3 wt % of silica fly ash, 4.3 wt % of gypsum

| | | | | | | | | |
|---|---|---|---|---|---|---|---|---|
| Comparison | — | 0 | — | 0 | 0.40 | 14.0 | 25.1 | 50.2 |
| Accelerated | Na sulfate | 3.0 | — | 0 | 0.40 | 16.1 | 22.6 | 54.5 |
| Activated according | Na sulfate | 3.0 | Na gluconate | 0.05 | 0.40 | 18.4 | 32.4 | 63.7 |
| to the invention | | | | | | | | |

B) 55.1 wt % of clinker, 36.7 wt % of silica fly ash, 4.1 wt % of metakaolin, 4.1 wt % of gypsum

| | | | | | | | | |
|---|---|---|---|---|---|---|---|---|
| Accelerated | Na sulfate | 3.0 | — | 0 | 0.40 | 18.9 | 29.0 | 57.9 |
| Activated | Na sulfate | 3.0 | Na gluconate | 0.025 | 0.40 | 20.8 | 34.8 | 57.0 |
| according to the | | | | | | | | |
| invention | | | | | | | | |

C) 57.4 wt % of clinker, 38.3 wt % of silica fly ash, 4.3 wt % of gypsum

| | | | | | | | | |
|---|---|---|---|---|---|---|---|---|
| Comparison | — | 0 | — | 0 | 0.45 | 9.7 | 19.6 | 45.6 |
| Activated I | Glauberite | 4.8 | Na gluconate | 0.05 | 0.45 | 12.4 | 25.1 | 49.1 |
| Activated II | Glauberite | 4.8 | Citric acid | 0.07 | 0.45 | 10.5 | 23.2 | 47.6 |
| Activated III | Glauberite | 4.8 | Bayhibit | 0.07 | 0.45 | 11.8 | 23.4 | 45.8 |

D) 28.7 wt % of clinker, 66.8 wt % of granulated blast-furnace slag , 4.5 wt % of gypsum

| | | | | | | | |
|---|---|---|---|---|---|---|---|
| Comparison | — | 0 | — | 0 | 3.2 | 7.5 | 50.9 |
| Accelerated | Na sulfate | 3.0 | — | 0 | 4.2 | 7.2 | 48.3 |
| Retarded | — | 0 | Na gluconate | 0.05 | 1.6 | 7.0 | 58.7 |
| Activated | Na sulfate | 3.0 | Na gluconate | 0.05 | 4.5 | 10.8 | 58.2 |
| according to the | | | | | | | |
| invention | | | | | | | |

E) 28.7 wt % of clinker, 66.8 wt % of granulated blast-furnace slag, 4.5 wt % of gypsum

| | | | | | | | | |
|---|---|---|---|---|---|---|---|---|
| Comparison | — | 0 | — | 0 | 0.45 | 3.8 | 10.5 | 57.8 |
| Activated I | Glauberite | 4.8 | Na gluconate | 0.05 | 0.45 | 5.7 | 17.6 | 58.3 |
| Activated II | Glauberite | 4.8 | Citric acid | 0.07 | 0.45 | 4.2 | 14.8 | 58.8 |
| Activated III | Glauberite | 4.8 | Bayhibit | 0.07 | 0.45 | 5.1 | 15.4 | 56.0 |

F) 70 wt % of clinker, 25.5 wt % of ground limestone (LS), 4.5 wt % of gypsum

| | | | | | | | | |
|---|---|---|---|---|---|---|---|---|
| Comparison | — | 0 | — | 0 | 0.50 | 11.3 | 21.0 | 44.7 |
| Activated | Na sulfate | 3.0 | Na gluconate | 0.05 | 0.50 | 17.4 | 31.7 | 46.1 |
| according to the | | | | | | | | |
| invention | | | | | | | | |

G) 29 wt % of clinker, 38 bis 57 wt % of granulated blast-furnace slag (gbfs), 10 bis 30 wt % of LS, 4.3 wt % of gypsum

| | | | | | | | | |
|---|---|---|---|---|---|---|---|---|
| Comparison: 60% | — | 0 | — | 0 | 0.45 | ns | 14.0 | 57.0 |
| gbfs, 10% LS | | | | | | | | |
| Activated: 60% | Na sulfate | 3.0 | Na gluconate | 0.05 | 0.45 | ns | 20.7 | 63.5 |
| gbfs, 10% LS | | | | | | | | |
| Comparison. 40% | — | 0 | — | 0 | 0.45 | ns | 12.1 | 48.8 |
| gbfs, 30% LS | | | | | | | | |
| Activated: 40% | Na sulfate | 3.0 | Na gluconate | 0.05 | 0.45 | ns | 18.6 | 53.3 |
| gbfs, 30% LS | | | | | | | | |

H) 28.7 wt % of clinker, 66.8 wt % of granulated blast-furnace slag, 4.5 wt % of gypsum

| | | | | | | | | |
|---|---|---|---|---|---|---|---|---|
| Comparison | — | 0 | — | 0 | 0.45 | 4.4 | 9.1 | 64.7 |
| Accelerated | Ca nitrate | 3.0 | — | 0 | 0.45 | 4.5 | 12.7 | 63.3 |
| Activated | Ca nitrate | 3.0 | Na gluconate | 0.05 | 0.45 | 4.2 | 12.7 | 71.3 |
| according to the | | | | | | | | |
| invention | | | | | | | | |
| Accelerated | Ca nitrite | 3.0 | — | 0 | 0.45 | 5.1 | 12.3 | 73.1 |
| Activated | Ca nitrite | 3.0 | Na gluconate | 0.05 | 0.45 | 5.3 | 13.5 | 80.7 |
| according to the | | | | | | | | |
| invention | | | | | | | | |

I) 57.4 wt % of clinker, 38.3 wt % of natural puzzolan (volcanic tuff), 4.3 wt % of gypsum

| | | | | | | | | |
|---|---|---|---|---|---|---|---|---|
| Comparison | — | 0 | — | 0 | 0.45 | 10.9 | 19.8 | 44.2 |
| Accelerated | Na sulfate | 3.0 | — | 0 | 0.45 | 15.9 | 23.4 | 39.4 |
| Activated | Na sulfate | 3.0 | Na gluconate | 0.05 | 0.45 | 17.6 | 26.8 | 42.9 |
| according to the | | | | | | | | |
| invention | | | | | | | | |

K) 55.1 wt % of clinker, 36.7 wt % of natural puzzolan (volcanic tuff), 4.1 wt % of metakaolin, 4.1 wt % of gypsum

| | | | | | | | | |
|---|---|---|---|---|---|---|---|---|
| Comparison | — | 0 | — | 0 | 0.45 | 11.2 | 20.1 | 48.1 |
| Accelerated | Na sulfate | 3.0 | — | 0 | 0.45 | 17.8 | 26.2 | 44.5 |
| Activated | Na sulfate | 3.0 | Na gluconate | 0.05 | 0.45 | 19.9 | 26.9 | 43.9 |
| according to the | | | | | | | | |
| invention | | | | | | | | |

L) 95.7% clinker, 4.3% gypsum

| | | | | | | | | |
|---|---|---|---|---|---|---|---|---|
| Comparison | — | 0 | — | 0 | 0.50 | 21.8 | 35.2 | 60.5 |
| Accelerated | Na sulfate | 3.0 | — | 0 | 0.50 | 30.0 | 41.0 | 61.5 |
| Activated | Na sulfate | 3.0 | Na gluconate | 0.05 | 0.50 | 33.3 | 45.6 | 65.6 |
| according to the | | | | | | | | |
| invention | | | | | | | | |

The results of systems A) to C) demonstrate the effectiveness of the combined activation system according to the invention comprising Na sulfate and glauberite (Na₂Ca(SO)₂) as examples of activators, combined with various retarders, in the enhancement of the strengths of composite cements containing puzzolanic materials such as, for instance, silica fly ash in elevated amounts, and optionally metakaolin. The positive effect of the combination of an activator and a retarder relative to the mere addition of an activator becomes clear.

Systems D) to E) reveal the significant increase in the strengths of mortars comprising composite cements containing major amounts of slag sand and exemplary combinations of activators and retarders according to the present invention. Also here, the combination of an activator and a retarder results in a significantly enhanced strength development in all stages as compared to the addition of an activator or a retarder alone.

The effectiveness of the activation system clearly depends on the quality of the cement components. The response to the activation depends on the reactivity and chemical composition of the former. The Examples elucidate the role of the activator, that of the retarder, and that of the combined addition according to the present invention. While the addition of an activator above all increases the early strength, and rather reduces more or less the late strength as a function of the properties of the slag sand and the clinker, the addition of the retarder alone leads to the opposite, namely a reduction of the early strength, yet an increase in the late strength. It is only the combination of the two components according to the invention which produces good results in all stages.

System F) indicates the effectiveness of the combined activation system according to the present invention, if the latter is applied to limestone composite cements. Surprisingly, an activation of the composite cement is also achieved in the presence of elevated amounts of the primarily inert limestone due to the addition of the activation system according to the invention, which leads to a substantial strength increase in all stages.

System G) demonstrates the effect of the combined activation system if the latter is used in ternary composite cements. In conventional composite cements, the replacement of the reactive slag sand with the primarily inert limestone would result in a reduction of the strength in all stages proportionally to the amount of the replaced slag sand. This is confirmed by the data relating to the various non-activated comparative cements. Where the combined activation system according to the present invention is applied, the reduction of the early strength, which is caused by the replacement of the reactive slag sand with the substantially nonreactive limestone, is more than compensated for. Even the late strength is significantly increased.

System H) elucidates the effectiveness of the addition of a retarder to a slag sand composite system activated by Ca nitrate and Ca nitrite. In both systems, the late strength was significantly enhanced by the addition of the retarder, without affecting the early strength.

Systems I) and K) include Examples of puzzolan composite cements containing elevated amounts of volcanic tuff. System K) additionally contains slight amounts of metakaolin. The activation with Na sulfate results in a significant increase in the early strength at the expense of the strength after 28 days. The addition of the retarder further raises the early strength while partially reducing the loss of strength in the later stage.

System L) illustrates the effectiveness of the combined activation system according to the invention containing conventional Portland cement without secondary cement materials. The combined addition of activator and retarder increases the strength in all stages as compared to the system containing only one activator.

To sum up the Examples specified in Table 1, the new, combined activation system as claimed in the present application is effective in significantly increasing the mortar strengths of composite cements based on fly ash, slag sand, puzzolans, and combinations thereof. The combination of an activator and a retarder surpasses the performances of non-activated comparative systems and those of cements containing either the activator or the retarder alone. In an activated composite cement or conventional Portland cement, a significantly higher strength can thus be achieved according to the invention with constant clinker contents, or the clinker content can be significantly reduced while, at the same time, maintaining a comparable strength level.

### EXAMPLE 2

In Example 2, a cement according to system D) was tested in concrete having the following composition:

380 kg/m³ cement D

112 kg/m³ 0-0.2 mm sand

102 kg/m³ 0.2-0.5 mm sand

118 kg/m³ 0.5-1.0 mm sand

203 kg/m³ 1.0-2.0 sand

337 kg/m³ 2.0-4.0 sand

501 kg/m³ 4-8 mm sand

505 kg/m³ 8-16 mm sand

152 kg/m³water

4.56 kg/m³concrete aggregates

Table 2 shows the results for the compressive strength of concrete containing said cement along with the activation system according to the invention as compared to a non-activated comparative cement, produced and stored at 22° C. and at 27° C.

TABLE 2

| | | Na | Na | Compressive | | |
|---|---|---|---|---|---|---|
| | Temp. | sulfate | gluconate | strength MPa | | |
| Cement D | ° C. | wt % | wt % | 1d | 2d | 28d |
| Comparison | 20 | 0 | 0 | 8 | 16 | 55 |
| Activated | 20 | 3 | 0.05 | 9 | 23 | 62 |
| Comparison | 27 | 0 | 0 | 14 | 29 | 66 |
| Activated | 27 | 3 | 0.05 | 24 | 34 | 57 |

These data indicate that a hydraulic composition according to the present invention provides significantly enhanced strength levels, in particular in early phases, even at elevated temperatures.

1-25. (canceled)

26. A hydraulic binder containing 25 to 85 wt % of cement clinker, 0 to 7 wt % of CaSO4, and one or more mineral additives in amounts of from 15 to 75 wt %, based on the hydraulic binder, and 1 to 10 wt % of a dual setting control system comprising an activator and a retarder, wherein the weight ratio of activator to retarder, based on the dry substance, is selected to be (a) greater than 85:15, (b) greater than 90:10, (c) greater than 95:5, or (d) greater than 98:2, wherein the activator comprises at least one compound selected from the group consisting of carbonates of alkali metals, chlorides of alkali metals, sulfates of alkali metals, nitrates of alkali metals, nitrites of alkali metals, thiocyanates of alkali metals, thiosulfates of alkali metals, and salts of organic acids of alkali metals and the retarder comprises at least one compound selected from the group consisting of Zn and lead salts, phosphates, phosphonates, boric acids, silicofluorides, organic acids, and salts thereof, sugars and derivatives thereof.

27. A hydraulic binder according to claim 26, wherein 1 to 7 wt % of CaSO4 is contained.

28. A hydraulic binder according to claim 26, wherein formiates and acetates are used as said salts of organic acids contained in said activator.

29. A hydraulic binder according to claim 26, wherein said alkali metal is Na, K or Li.

30. A hydraulic binder according to claim 26, wherein said phosphonate is phosphonobutanetricarboxylic acid and/or aminomethylene phosphonate.

31. A hydraulic binder according to claim 26, wherein said aminomethylene phosphonate is amino-tris-methylene phosphonate.

32. A hydraulic binder according to claim 26, wherein said organic acids contained in said retarder are hydroxycarboxylic acids.

33. A hydraulic binder according to claim 32, wherein said hydroxycarboxylic acids are gluconic acid or tartaric acid.

34. A hydraulic binder according to claim 26, wherein the dual setting control system is used in amounts of from 1 to 7 wt % based on the hydraulic binder.

35. A hydraulic binder according to claim 34, wherein the dual setting control system is used in amounts of from 2 to 3 wt % based on the hydraulic binder.

36. A hydraulic binder according to claim 26, wherein said activator further comprises at least one compound selected from the group consisting of polyalcohols, glycerol or glycol derivatives.

37. A hydraulic binder according to claim 36, wherein said polyalcohol is triisopropanolamine.

38. A hydraulic binder according to claim 26, wherein the activator is used in amounts of from 1 to 6 wt % based on the hydraulic binder.

39. A hydraulic binder according to claim 38, wherein the activator is used in amounts of from 2 to 4 wt % based on the hydraulic binder.

40. A hydraulic binder according to claim 26, wherein said activator comprises Na₂SO₄.

41. A hydraulic binder according to claim 26, wherein said retarder comprises an alkali metal salt and/or earth alkali metal salt of gluconic acid.

42. A hydraulic binder according to claim 41, wherein said retarder comprises Na gluconate.

43. A hydraulic binder according to claim 26, wherein said retarder is used in an amount of from 0.01-0.5 wt % based on the hydraulic binder.

44. A hydraulic binder according to claim 43, wherein said retarder is used in an amount of from 0.03-0.06 wt % based on the hydraulic binder.

45. A hydraulic binder according to claim 26, wherein said mineral additive comprises slag sand, fly ash, natural puzzolans, burnt clays, ground limestone, or combinations thereof.

46. A hydraulic binder according to claim 26, wherein reactive clays are additionally contained in amounts of from 1 to 15 wt %, based on the hydraulic binder.

47. A hydraulic binder according to claim 46, wherein metakaolin is used as reactive clay.

48. An activating system comprising a dual setting control system including an activator and a retarder, wherein the ratio of activator to retarder is selected to be (a) greater than 85:15, (b) greater than 90:10, (c) greater than 95:5, or (d) greater than 98:2, based on the dry substance, wherein the activator comprises at least one compound selected from the group consisting of carbonates of alkali metals, chlorides of alkali metals, sulfates of alkali metals, nitrates of alkali metals, nitrites of alkali metals, thiocyanates of alkali metals, thiosulfates of alkali metals, and salts of organic acids of alkali metals and the retarder comprises at least one compound selected from the group consisting of Zn and lead salt, phosphates, phosphonates, boric acids, silicofluorides, organic acids, and salts thereof, sugars and derivatives thereof.

49. An activating system according to claim 48, wherein formiates and acetates are used as said salts of organic acids contained in said activator.

50. An activating system according to claim 48, wherein said alkali metal is Na, K or Li.

51. An activating system according to claim 48, wherein said phosphonate is phosphonobutanetricarboxylic acid and/or aminomethylene phosphonate.

52. An activating system according to claim 48, wherein said aminomethylene phosphonate is amino-tris-methylene phosphonate.

53. An activating system according to claim 48, wherein said organic acids contained in said retarder are hydroxycarboxylic acids.

54. An activating system according to claim 53, wherein said hydroxycarboxylic acids are gluconic acid or tartaric acid.

55. An activating system according to claim 48, wherein the activator further comprises at least one compound selected from the group consisting of polyalcohols, glycerol or glycol derivatives.

56. An activating system according to claim 55, wherein said polyalcohol is triisopropanolamine.

57. An activating system according to claim 48, wherein said activator comprises Na₂SO₄.

58. An activating system according to claim 48, wherein said retarder comprises an alkali metal salt and/or earth alkali metal salt of gluconic acid.

59. An activating system according to claim 48, wherein said retarder comprises sodium gluconate.

60. A ready-mix concrete mixture comprising an activating system according to 48.

61. A ready-mix concrete mixture according to claim 60 comprising said activating system in an amount of from 1 to 10 wt %, based on the hydraulic binder.

62. A ready-mix concrete mixture comprising a hydraulic binder according to claim 26.

63. A molding produced using a hydraulic binder or an activating system according to claim 26.
